(19) United States
(12) Patent Application Publication
(10) Pub. No.: US 2008/0196670 A1
(43) Pub. Date: Aug. 21, 2008

(54) Heated animal-actuated water feeder

(75) Inventor: Benjamin T. Clark, South Bend, IN (US)

Correspondence Address: R. Tracy Crump, P.O. Box 604, New Carlisle, IN, 46552, US

(73) Assignee: Farm Innovators, Inc.

(21) Appl. No.: 11/708,388

(22) Filed: Feb. 20, 2007

(51) Int. Cl. A01K 7/00

(52) U.S. Cl. 119/73

(57) ABSTRACT

This water feeder includes a heating element interposed between the fluid reservoir and a heater base. The fluid reservoir is press fit onto a heater base, which includes a bottom tray and an upright back. The heating element includes a length of electrical resistance heating wire affixed to a sheet of pliable thermal conductive foil. The heating element covers both the inside of the base tray to contact the bottom of the fluid reservoir and the inside face of the base back to contact the back wall of the fluid reservoir.

This invention relates to water feeders for small animals, such as rabbits, and specifically a heated water feeder that prevents water from freezing inside the valve mechanism of the dispensing nozzle.

### BACKGROUND OF THE INVENTION

Animal actuated water feeders are commonly used for small animals, such as rabbits. These types of water feeders typically comprise a cylindrical plastic water bottle and a cap with a tubular stainless steel nozzle. A stainless steel ball bearing inside the nozzle forms a simple gravity feed valve for metering water through the nozzle. Animal displace the ball upward with their tongues to open the valve, which automatically closes under gravity when the ball settles.

Heretofore, conventional water feeders have been prone to freezing in extreme environments. When ambient temperatures drop below freezing, rabbit water feeders are inoperable because the water inside the reservoir bottle and nozzle freezes. The stainless steel construction of the nozzle tube and ball valve are particularly prone to freezing shut in sub-freezing temperatures. Attempts to address the freezing problems affecting animal actuated water feeders have focused on heating reservoir bottles with electrical resistance heating wire and heating foils. These attempts have been unsuccessful, because while heating the reservoir bottle does prevent water within the bottle from freezing, it does not effectively prevent the small volume of water within the dispensing nozzle from freezing, which renders the water feeder inoperable. Because the dispensing nozzles are constructed from brass or stainless steel, thermal energy is quickly lost through the nozzle. When temperatures drop below the freezing point, the small volume of water within the nozzle can quickly freeze and render the nozzle inoperable. Even if the water temperature inside the fluid reservoir is maintained above freezing, the thermal energy transferred from the heating element to the reservoir is not localized sufficiently near the nozzle to prevent the small volume of water within the nozzle from freezing.

### SUMMARY OF THE INVENTION

The water feeder embodying the present invention eliminates the problem of water freezing within the dispensing nozzle common to gravity feed water feeders. The water feeder of the present invention includes a heating element interposed between the fluid reservoir and a heater base. The fluid reservoir is press fit onto a heater base, which includes a bottom tray and an upright back. The heating element includes a length of electrical resistance heating wire affixed to a sheet of pliable thermal conductive foil. The heating element covers both the inside of the base tray to contact the bottom of the fluid reservoir and the inside face of the base back to contact the back wall of the fluid reservoir. The majority of the heating wire is concentrated across the portion of the heating element that covers the bottom of the fluid reservoir so that more thermal energy is conducted into the bottom of the reservoir and near the nozzle than across the back of the reservoir. Concentrating the majority of the heating wire near across the bottom of the reservoir near the nozzle, helps ensure that water inside the nozzle will not freeze when ambient temperatures drop below freezing. Accordingly, the water feeder embodying this invention prevents water from freezing inside the dispensing nozzle, as well as within the reservoir.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the water feeder of this invention mounted to the side of a conventional animal cage;

FIG. 2 is an exploded perspective view of the water feeder of FIG. 1;

FIG. 3 is a partial side sectional view of the water feeder of FIG. 1;

FIG. 4 is a side sectional view of the nozzle of water feeder of FIG. 1 shown in a closed position; and

FIG. 5 is a side sectional view of the nozzle of water feeder of FIG. 1 shown in an open position.

### DESCRIPTION OF THE PREFERRED EMBODIMENT

Referring now to the drawings, an embodiment of the heated animal actuated water feeder of this invention is designated generally as reference numeral 10. Water feeder 10 is designed and intended to be hung on the outside of conventional animal cages using wire bands or spring fasteners 12. As shown, water feeder 10 includes a fluid reservoir 20, a heater base 50 and a heating element 60.

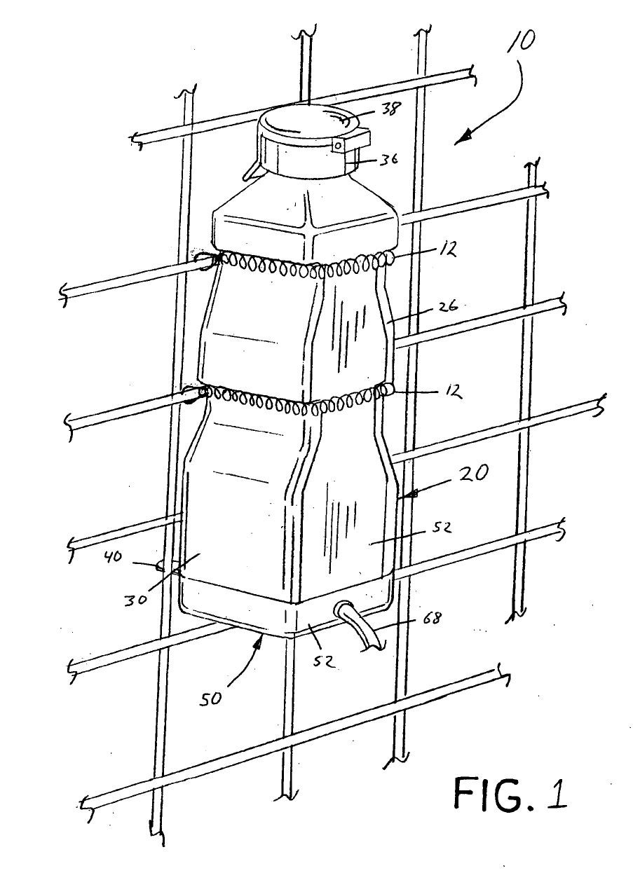

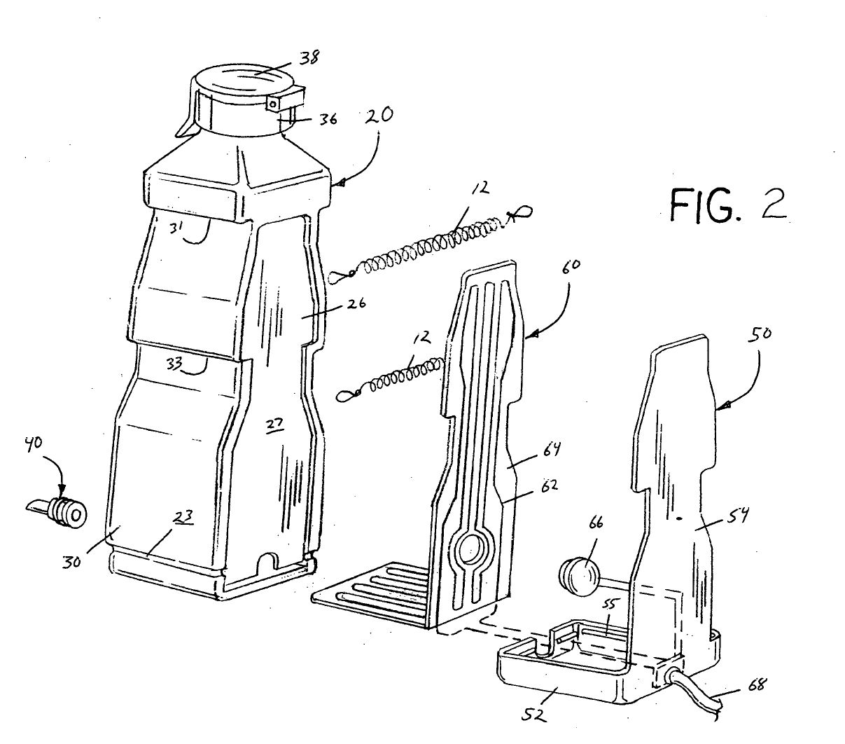

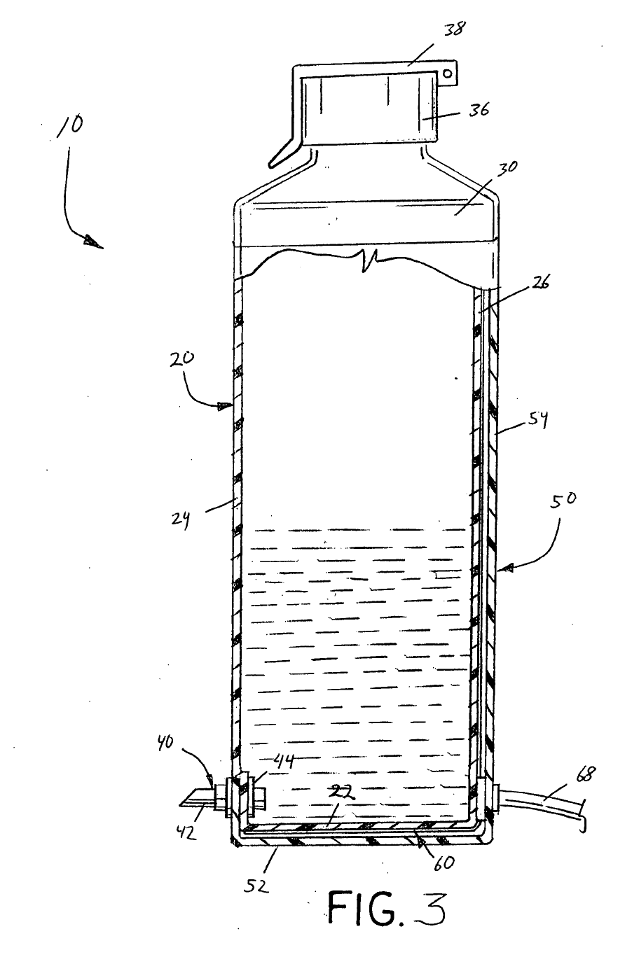

Fluid reservoir 20 is ideally constructed of a transparent plastic, although it can be constructed of any suitable material. Reservoir 20 is shaped and dimensioned depending on each particular application, but for use with small animals, such as rabbits, fluid reservoirs are sized generally to hold approximately 32 fluid ounce. As shown, reservoir 20 has a body with a flat rectangular bottom wall 22, a flat front wall 24, a substantially flat back wall 26 and contoured side walls 30, which converge at the top to form an open mouth of the reservoir. Sidewalls 30 have two shoulders 31 and 33, which provide contact edges for retaining wires or springs 12 that hold water feeder 10 to a wire animal cage (FIG. 1). Back wall 26 has a recessed area 27 inset from its peripheral edge. Reservoir 20 also has a peripheral channel 23 that extends across front, back and side walls 24, 26 and 30.

A threaded cap 36 is turned onto the top of reservoir 20 to enclose the mouth of reservoir 20. Cap 36 has an air vent (not shown), which allows water feeder 10 to use a pressure feed valve mechanism, rather than a gravity feed ball valve as in conventional water feeders. As shown, cap 30 has a flip up lid 38 that allows access to reservoir 20 without unscrewing the cap.

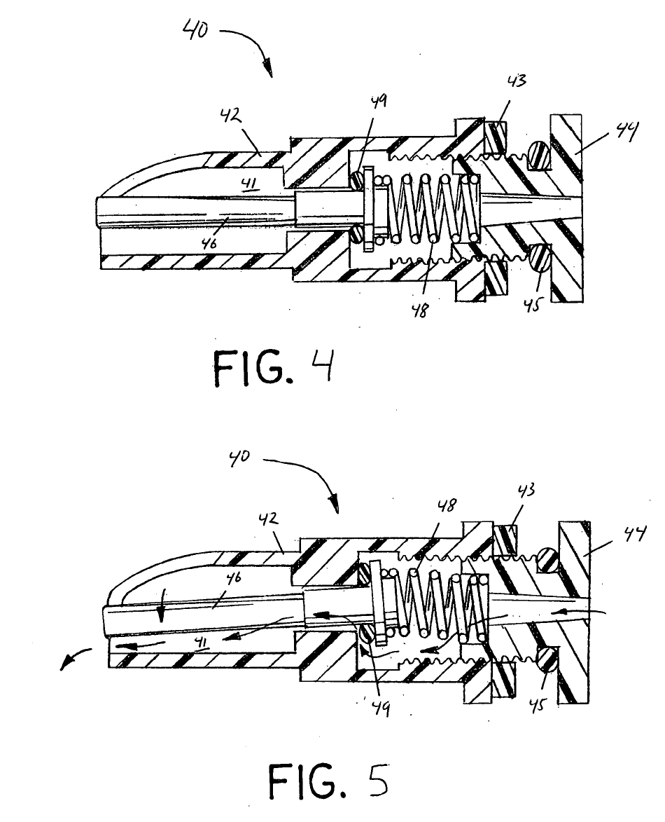

Reservoir 20 also includes a dispensing nozzle 40 extending from the front wall 24 just above the bottom wall 22. Nozzle 40 includes a tubular body or sleeve 42 and threaded fitting 44. Sleeve 42 and fitting 44 are both made of brass, which has a relatively high thermal conductivity. As show in FIGS. 4 and 5, sleeve 42 is threaded onto fitting 44, which extends through a bore in reservoir front wall 24. It should be noted that sleeve extends only about an inch from reservoir front wall 24. A flat rubber washer 43 and an o-ring 45 hermetically seals the connection between sleeve 42, fitting 44 and reservoir front wall 24. Sleeve 42 and fitting 44 each have a longitudinal bore, which forms a flow passage 41. A valve stem 46 is seated longitudinally within flow passage 41 and pressed against an internal shoulder 47 formed in sleeve 42 by a coil spring 48. Valve stem 46 is seated against an O-ring 49, so that valve stem 42 closes flow passage 41 when the valve stem is pressed axially against shoulder 47 (FIG. 4). When valve stem is deflected off axis by an animal, flow passage 41 is opened and water can pass through nozzle 40 (FIG. 5). It should be noted that valve mechanism of nozzle 40 is not limited to the precise form or embodiment illustrated and described herein and any suitable valve mechanism can be incorporated within the teaching of this invention.

Heater base 50 is constructed of thermally resistant plastic or other suitable materials and includes a tray 52 and an upright back 56. Base tray 52 has short peripheral sidewalls 54 diverging from a rectangular bottom. The inner face of tray sidewalls 54 has a rib 55. Base back 56 extends integrally from the rear sidewall of tray 52. As shown, reservoir 20 is press fit to heater base 50. The bottom of reservoir 20 is seated into tray 52 with ribs 55 extending into reservoir channels 23 and base back 56 seated within back wall recess 27. Ideally, reservoir 20 is bonded to heater base 50 with an adhesive. While reservoir 20 and heater base 50 are connected by a press fit engagement and secured with an adhesive, other means of securing the reservoir and base can be employed within the teachings of this invention.

Heater element 60 includes a length of electrical resistance heating wire 62 affixed to a backing 64 of a thin sheet of pliable thermal conductive material. Wire backing 64 has a reflective foil covering, which conduct thermal energy from the resistance wire into reservoir 20. Heating element 60 also includes a thermostat 66. Thermostat 66 is mounted to base back 56 and extends through an opening in wire backing 64 to contact reservoir back wall 26. Typically, thermostat 66 is bonded to base back 56 by a suitable adhesive. Thermostat 66 is of conventional design and controls the operation of heating element 60 by terminating the electrical current to the heating wire when water inside reservoir 20 is above a threshold temperature. Heating element 60 is powered by AC line current. A conventional electric power cord 68 is electrically connected to resistance wire 62 and thermostat 66 to supply the AC line current to heating element 60. Although, heating element 60 is preferably powered by an AC line, the heating element can be modified for DC electrical power within the teachings of this invention.

As shown, heating element 60 is interposed between reservoir 20 and heater base 50 and folded so that a portion of heating element 60 covers both reservoir bottom wall 22 and substantially all of reservoir back wall 26. It should be noted that the area of the portion of heating element 60 covering base tray 52 is approximately one quarter to one third of the total area of the heating element, but the length of heating wire 62 used within on the portion of heating element 60 that covers base tray 52 compared to the length of resistance wire 62 used in the portion of heating element 60 covering base back 56 has an approximate 5 to 9 ratio. Even though a proportionately smaller area, more resistance wiring 62 is used in the portion of the heating element 60 covering the reservoir bottom wall 22 than in the portion of the heating element covering the reservoir back wall 26. Resistance wire 62 is concentrated on the portion that covers base tray 52 so that more thermal energy is conducted into reservoir bottom wall 22 in close proximity of nozzle 40 than the thermal energy conducted across reservoir back wall 26. Concentrating the majority of the heating wire across the bottom of reservoir 20 helps ensure that water inside nozzle 40 will not freeze when ambient temperatures drop below freezing. Heating element 60 employs approximately 4.25-4.75 linear feet of heating wire and the heating wire has a resistance value ranging generally between 100-200 ohms per foot of wire. For most water feeder applications, 20 watts of electrical energy can be used to prevent 12-16 ounces of water from freezing in the feeder when the ambient temperature drops to −10° F.

One skilled in the art will note that the water feeder embodying this invention prevents water from freezing inside the dispensing nozzle, as well as within the reservoir. Concentrating a larger portion of the heating wire across the bottom of the reservoir near the nozzle helps prevent water from freezing inside the nozzle. Due to the concentration of heating wire across the bottom of the reservoir, the water in the reservoir is primarily heated from the bottom up. Because the heating element applies thermal energy where it is most critical, the water feeder of this invention remains operable in ambient temperatures below freezing.

The design and construction of the dispensing nozzle also helps transfer thermal energy through the nozzle to prevent freezing inside the nozzle. The tubular nozzle sleeve and fitting are constructed of brass, which has a high thermal conductivity. The length of nozzle sleeve is only long enough to extend through a conventional wire cage to be accessible to the animal. Shorting the length of the nozzle sleeve means that less thermal energy is lost to atmosphere as the energy is transferred through the nozzle by conduction. The brass fitting that secures the brass nozzle sleeve to the reservoir also provides a relative large surface area through which thermal energy in the water can be transferred.

The reservoir configuration also allows the heating element to be located closer to the nozzle. Because of the proximity of the dispensing nozzle to the concentrated heating wire across the bottom of the reservoir, thermal energy is transferred through the rising warmed water into the nozzle. Because warm water rises, the thermal energy emitted from the heating element across the bottom of the reservoir conducts past the brass nozzle fitting. The brass nozzle fitting transfers the thermal energy from the warm water through the brass nozzle sleeve, which helps prevent freezing inside the nozzle.

The design of the reservoir also eliminates other problems associated with conventional gravity feed rabbit water feeders. The reservoir configuration uses a venting cap and moves the nozzle to so that the water feeder of this invention can employ pressure feed valve mechanism rather than gravity feed valve mechanism.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An animal actuated heated water feeder comprising:
a heater base, the heater base includes a tray and an upright back extending integrally from the tray;
a fluid reservoir, the fluid reservoir having an interior defined by a bottom wall, front wall, a back wall and two sidewalls, the reservoir connected to the heater base with the tray covering the reservoir bottom wall and the base back overlying the reservoir back wall;
a nozzle protruding from the reservoir front wall adjacent the reservoir bottom wall for communicating the fluids contained in the reservoir therethrough; and
a heating element juxtaposed between the reservoir and heater base for emitting thermal energy to heat the reservoir, the heating element having a first portion contacting and overlying the reservoir bottom wall and a second portion contacting and overlying the reservoir back wall.

2. The water feeder of claim 1 and a thermostat mounted between the heater base and reservoir and electrically connected to the heating element for regulating the thermal energy from the heating element.

3. The water feeder of claim 2 wherein the thermostat is mounted between the base back and reservoir back wall.

4. The water feeder of claim 1 wherein the heating element includes a length of electrical resistance wire.

5. The water feeder of claim 2 wherein a first portion of the length of resistance wire emits thermal energy through the reservoir bottom wall and a second portion of the length of resistance wire emits thermal energy through the reservoir back wall, the ratio length of resistance wire between the first portion of the length of resistance wire to the second portion of the length of resistance wire is 5 to 9.

6. The water feeder of claim 4 wherein the length of resistance wire is affixed to a sheet of thermal conductive backing.

7. An animal actuated heated water feeder comprising:
a heater base, the heater base includes a tray and an upright back extending integrally from the tray;
a fluid reservoir, the fluid reservoir having an interior defined by a bottom wall, front wall, a back wall and two sidewalls, the reservoir front wall, reservoir back wall and reservoir side walls converge away from the reservoir bottom wall to form a neck having an open mouth into the reservoir interior, the reservoir connected to the heater base with the tray covering the reservoir bottom wall and the base back overlying the reservoir back wall;
a cap attachable over the reservoir mouth and having a vent for allowing air to enter the reservoir interior,
a nozzle protruding from the reservoir front wall adjacent the reservoir bottom wall for communicating the fluids contained in the reservoir therethrough; and
a heating element juxtaposed between the reservoir and heater base for emitting thermal energy to heat the reservoir, the heating element having a first portion contacting and overlying the reservoir bottom wall and a second portion contacting and overlying the reservoir back wall.

8. The water feeder of claim 7 and a thermostat mounted between the heater base and reservoir and electrically connected to the heating element for regulating the thermal energy from the heating element.

9. The water feeder of claim 8 wherein the thermostat is mounted between the base back and reservoir back wall.

10. The water feeder of claim 8 wherein the heating element includes a length of electrical resistance wire.

11. The water feeder of claim 8 wherein a first portion of the length of resistance wire emits thermal energy through the reservoir bottom wall and a second portion of the length of resistance wire emits thermal energy through the reservoir back wall, the ratio length of resistance wire between the first portion of the length of resistance wire to the second portion of the length of resistance wire is 5 to 9.

12. The water feeder of claim 4 wherein the length of resistance wire is affixed to a sheet of thermal conductive backing.
